(19) United States
(12) Patent Application Publication
(10) Pub. No.: US 2026/0081276 A1
(43) Pub. Date: Mar. 19, 2026

(54) IN-VEHICLE BATTERY INSTALLATION STRUCTURE

(71) Applicant: TOYOTA JIDOSHA KABUSHIKI KAISHA, Toyota-shi (JP)

(72) Inventor: Nobuyuki YAMAZAKI, Okazaki-shi (JP)

(73) Assignee: TOYOTA JIDOSHA KABUSHIKI KAISHA, Toyota-shi (JP)

(21) Appl. No.: 19/249,010

(22) Filed: Jun. 25, 2025

(30) Foreign Application Priority Data
Sep. 13, 2024 (JP) 2024-159574

(51) Int. Cl. H01M 50/209; H01M 10/613; H01M 10/6554; H01M 50/249

(52) U.S. Cl. CPC H01M 50/209; H01M 10/613; H01M 10/6554; H01M 50/249

(57) ABSTRACT

An in-vehicle battery installation structure includes: a battery stack configured with multiple rectangular batteries stacked in a thickness direction of the rectangular batteries; a lower case that has an opening in an upper face; an upper case which is mounted on an upper part of the lower case so as to close the opening and of which a lower face is open; fastening members that fasten the lower case and the upper case together such that a force in the thickness direction is exerted from the lower case and the upper case onto the battery stack; and a cross-member which is a part of a vehicle body framework member supporting the lower case and the upper case and extends in a vehicle-width direction, and of which a lower face exerts a force in the thickness direction onto an upper face of the upper case.

### CROSS-REFERENCE TO RELATED APPLICATION

This application claims priority to Japanese Patent Application No. 2024-159574 filed on Sep. 13, 2024. The disclosure of the above-identified application, including the specification, drawings, and claims, is incorporated by reference herein in its entirety.

### BACKGROUND

### 1. Technical Field

The present disclosure relates to an in-vehicle battery installation structure.

### 2. Description of Related Art

Japanese Unexamined Patent Application Publication No. 2021-140874 (JP 2021-140874 A) discloses a battery module in which a spacer is provided between a battery stack and a case housing the battery stack to reduce variation in a pressing force applied to numerous secondary batteries composing the battery stack.

### SUMMARY

In recent years, improving energy density is demanded of battery modules. However, enhancing the energy density of a battery module requires reducing a space inside a case that members other than a battery stack occupy. That is, providing a spacer inside a battery case as in JP 2021-140874 A makes it difficult to improve the energy density of a battery module.

Taking this fact into consideration, the present disclosure aims to obtain an in-vehicle battery installation structure that helps enhance the energy density of a battery module having a case and a battery group.

An in-vehicle battery installation structure of a first aspect includes: a battery stack configured with a plurality of rectangular batteries stacked in a thickness direction of the rectangular batteries, each rectangular battery having a rectangular parallelepiped shape and provided with a terminal on each end face in a longitudinal direction; a lower case that has an opening in an upper face and houses the battery stack such that the thickness direction and a height direction coincide with each other; an upper case which is mounted on an upper part of the lower case so as to close the opening and of which a lower face is open; a fastening member that fastens the lower case and the upper case together such that a force in the thickness direction is exerted from the lower case and the upper case onto the battery stack; and a cross-member which is a part of a vehicle body framework member supporting the lower case and the upper case and extends in a vehicle-width direction, and of which a lower face exerts a force in the thickness direction onto an upper face of the upper case.

The in-vehicle battery installation structure of the first aspect has the battery stack that is configured with the rectangular batteries stacked in the thickness direction of the rectangular batteries, each rectangular battery having a rectangular parallelepiped shape and provided with the terminals respectively on both end faces in the longitudinal direction. Further, the lower case houses the battery stack such that the thickness direction and the height direction coincide with each other. Further, when the lower case and the upper case are fastened together by the fastening member, a force in the thickness direction of the rectangular batteries is exerted from the lower case and the upper case onto the battery stack. Further, the lower face of the cross-member extending in the vehicle-width direction exerts a force in the thickness direction of the rectangular batteries onto the upper face of the upper case. Thus, the in-vehicle battery installation structure of the first aspect makes it possible to exert a pressure in the thickness direction of the rectangular batteries onto each rectangular battery without providing a spacer. As such, the in-vehicle battery installation structure of the first aspect helps enhance the energy density of a battery module having a lower case, an upper case, and a battery stack.

An in-vehicle battery installation structure of a second aspect is that of the first aspect, wherein: the battery stack may have a plurality of planar battery units each configured with a plurality of the rectangular batteries arranged in a plane orthogonal to the thickness direction; the planar battery units may be arranged in the thickness direction; and in a gap left between two adjacent ones of the planar battery units, a single cooler may be provided that comes into contact with each of the rectangular batteries composing the planar battery units.

The in-vehicle battery installation structure of the second aspect makes it possible to cool numerous rectangular batteries by a small number of coolers.

An in-vehicle battery installation structure of a third aspect is that of the first aspect or the second aspect, wherein the lower face of the cross-member and the upper face of the upper case may come into contact with each other.

In the in-vehicle battery installation structure of the third aspect, the lower face of the cross-member exerts a pressure in the thickness direction of the rectangular batteries onto the upper face of the upper case, and this pressure is exerted from the upper case onto the battery stack. Thus, the in-vehicle battery installation structure of the third aspect makes it possible to enhance the energy density of a battery module by means of the cross-member.

As has been described above, the in-vehicle battery installation structure according to the present disclosure has an excellent advantage in that it helps enhance the energy density of a battery module having a case and a battery group.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of an in-vehicle battery installation structure according to an embodiment;

FIG. 2 is a schematic sectional view along arrowed line 2-2 of FIG. 1;

FIG. 3 is a perspective view of a battery cell;

FIG. 4 is a plan view of a lower case and a planar battery unit in a lowermost tier housed in the lower case;

FIG. 5 is a schematic sectional view of the lower case, an upper case separated from the lower case, and a battery stack; and

FIG. 6 is a sectional view similar to FIG. 5, with the lower case and the upper case fixed.

### DETAILED DESCRIPTION OF EMBODIMENTS

An in-vehicle battery installation structure according to an embodiment will be described below with reference to the accompanying drawings. Arrow UP, arrow FR, and arrow LH depicted in the drawings respectively indicate an upper side in a vehicle-height direction, a front side in a vehicle front-rear direction, and a left side in a vehicle right-left direction.

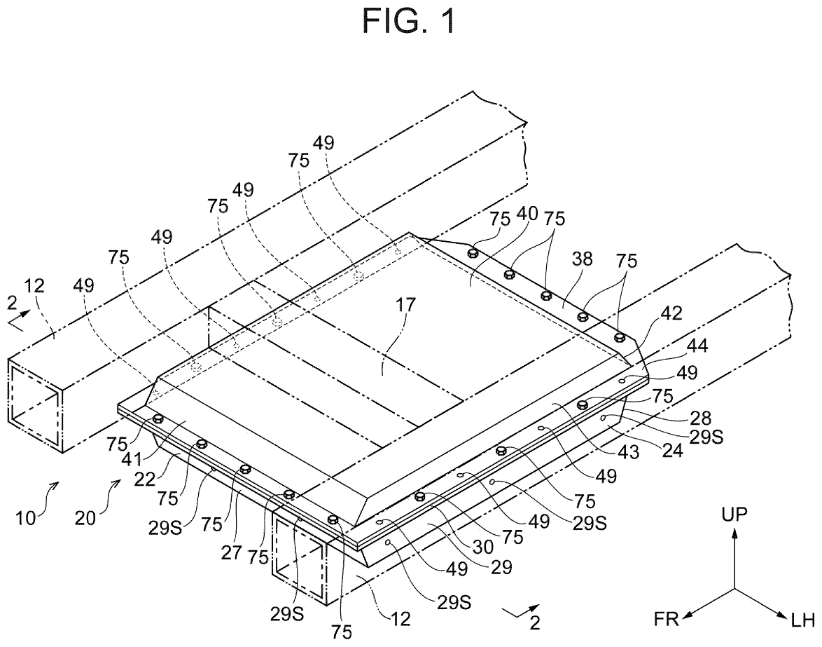

As shown in FIG. 1 and FIG. 2, a vehicle 10 to which the in-vehicle battery installation structure of the embodiment is applied includes a pair of right and left rockers 12 that is a part of a vehicle body framework member and extends in the vehicle front-rear direction, and a cross-member 17 that is a part of the vehicle body framework member and that extends in a vehicle-width direction (right-left direction) and has both end portions respectively fixed on the right and left rockers 12. The rockers 12 and the cross-member 17 are made of metal. As shown in FIG. 2, a cross-sectional shape of the rockers 12 is a quadrangular shape. In a bottom plate part 13 of each of the right and left rockers 12, a plurality of through-holes 14 is provided in a front-rear row (only one of which is shown in FIG. 1). At positions in an upper face of the bottom plate part 13 corresponding to the respective through-holes 14, weld nuts 15 concentric with the respective through-holes 14 are fixed.

A battery module 20 of the embodiment has a battery case 22, a battery stack 52, bolts 75, and nuts 76.

The battery case 22 has a lower case 24 and an upper case 38. The lower case 24 and the upper case 38 are integrally molded parts made of metal.

As shown in FIG. 1 and FIG. 4 to FIG. 6, the lower case 24 is a hollow body with an opening 25 formed in an upper face. The lower case 24 has a bottom plate part 26, a front plate part 27, a rear plate part 28, a pair of side plate parts 29, and a lower annular flange 30. A planar shape of the bottom plate part 26 is a rectangular shape that is longer in the front-rear direction than in the right-left direction. A lower end portion of the front plate part 27 is fixed on a front edge portion of the bottom plate part 26, and a lower end portion of the rear plate part 28 is fixed on a rear edge portion of the bottom plate part 26, and lower end portions of the right and left side plate parts 29 are respectively fixed on right and left side edge portions of the bottom plate part 26. Further, right and left side edge portions of the front plate part 27 are respectively fixed on front edge portions of the right and left side plate parts 29. Further, right and left side edge portions of the rear plate part 28 are respectively fixed on rear edge portions of the right and left side plate parts 29. The right and left side plate parts 29 are substantially parallel to the height direction. On the other hand, as seen in a side view, the front plate part 27 and the rear plate part 28 are inclined relative to the height direction. Further, as shown in FIG. 1 and FIG. 2, in the front plate part 27, the rear plate part 28, and each side plate part 29, a plurality of heat dissipation holes 29S is formed as through-holes. The lower annular flange 30 that has a quadrangular annular shape as seen in a plan view is fixed on upper edge portions of the front plate part 27, the rear plate part 28, and the side plate parts 29. In the lower annular flange 30, a plurality of first through-holes 34 is formed in a row in a circumferential direction of the lower annular flange 30. Further, at right and left side portions of the lower annular flange 30, a plurality of second through-holes 35 is formed in a row in the front-rear direction. Further, on a lower face of the lower annular flange 30, the weld nuts 76 concentric with the respective first through-holes 34 are fixed.

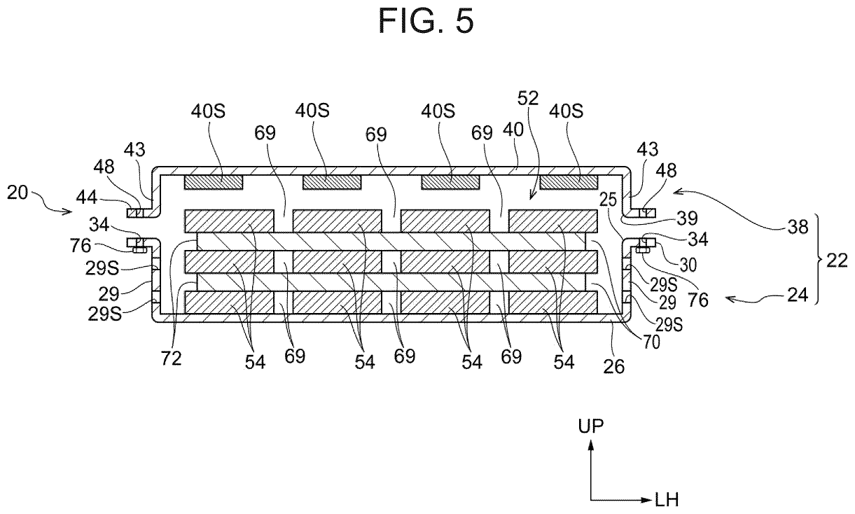

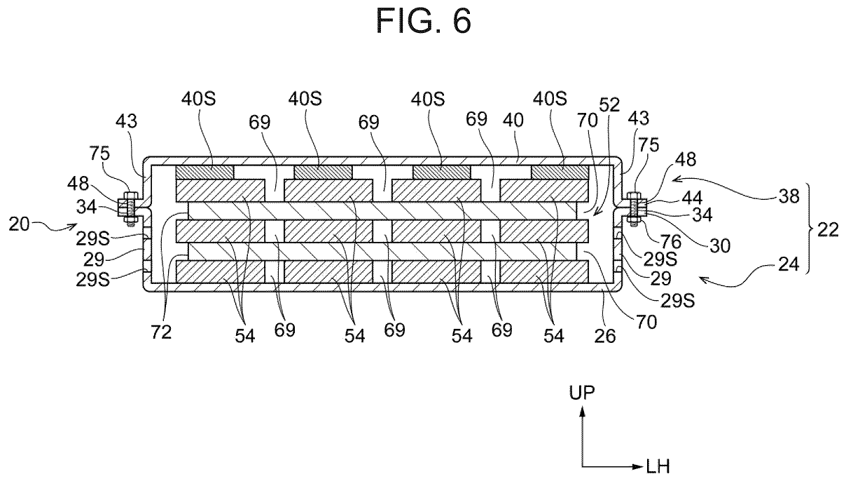

As shown in FIG. 1 and FIG. 4 to FIG. 6, the upper case 38 is a hollow body with an opening 39 formed in a lower face. The upper case 38 has a top plate part 40, a front plate part 41, a rear plate part 42, a pair of side plate parts 43, and an upper annular flange 44. A planar shape of the top plate part 40 is a rectangular shape that is longer in the front-rear direction than in the right-left direction. As shown in FIG. 5 and FIG. 6, on a lower face of the top plate part 40, a plurality of pressing ridges 40S extending in the front-rear direction is provided. An upper end portion of the front plate part 41 is foxed on a front edge portion of the top plate part 40, and an upper end portion of the rear plate part 42 is fixed on a rear edge portion of the top plate part 40, and upper end portions of the right and left side plate parts 43 are respectively fixed on right and left side edge portions of the top plate part 40. Further, right and left side edge portions of the front plate part 41 are respectively fixed on front edge portions of the right and left side plate parts 43. Further, right and left side edge portions of the rear plate part 42 are respectively fixed on rear edge portions of the right and left side plate parts 43. The right and left side plate parts 43 are substantially parallel to the height direction. On the other hand, as seen in a side view, the front plate part 41 and the rear plate part 42 are inclined relative to the height direction. The upper annular flange 44 having a rectangular annular shape as seen in a plan view is fixed on lower edge portions of the front plate part 41, the rear plate part 42, and the side plate parts 43. In the upper annular flange 44, a plurality of first through-holes 48 is formed in a row in a circumferential direction of the upper annular flange 44 (only two first through-holes 48 are shown in FIG. 5 and FIG. 6). Further, as shown in FIG. 1, at right and left side portions of the upper annular flange 44, a plurality of second through-holes 49 is formed in a row in the front-rear direction. A planar shape of the upper annular flange 44 is substantially the same as the planar shape of the lower annular flange 30. Further, the number of the first through-holes 48 is the same as the number of the first through-holes 34, and the number of the second through-holes 49 is the same as the number of the second through-holes 35.

As shown in FIG. 5 and FIG. 6, the battery stack 52 includes numerous battery cells 54, numerous busbars (not shown), and two coolers 72.

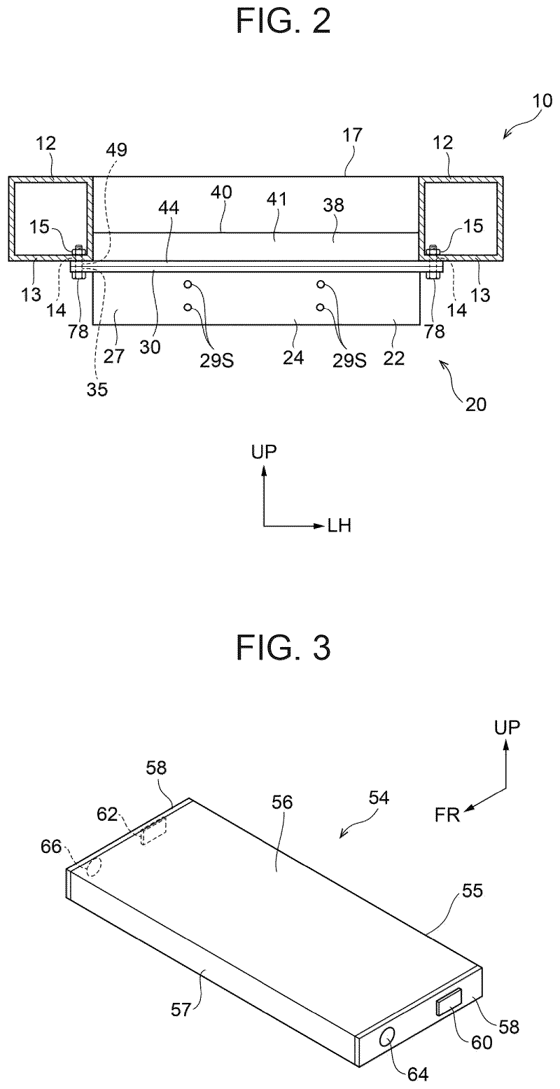

As shown in FIG. 3, the battery cell 54 that is a secondary battery is a rectangular battery having a main body case 55 having a rectangular parallelepiped shape, a pair of lid parts 58, a positive electrode terminal (terminal) 60, a negative electrode terminal (terminal) 62, and safety valves 64, 66. The metal main body case 55 is a hollow body that is open at both end portions in a longitudinal direction thereof (right-left direction). The main body case 55 includes a pair of upper and lower base plate parts 56, and a pair of side plate parts 57 that connect front edge portions of the upper and lower base plate parts 56 to each other and rear edge portions thereof to each other. The upper and lower base plate parts 56 are flat plates orthogonal to the height direction, and the right and left side plate parts 57 are flat plates orthogonal to the right-left direction.

The metal lid parts 58 are respectively fixed in openings on right and left sides of the base plate parts 56. On one of the lid parts 58, the positive electrode terminal 60 is provided, and on the other lid part 58, the negative electrode terminal 62 is provided. Further, on the lid parts 58, the safety valves 64, 66 are respectively provided. Further, an electrolytic solution or the like is housed in an internal space of the battery cell 54 formed by the main body case 55 and the lid parts 58. When a value of a pressure in this internal space reaches a predetermined pressure, the safety valves 64, 66 open to discharge smoke etc. generated in the internal space to an outside of the battery cell 54.

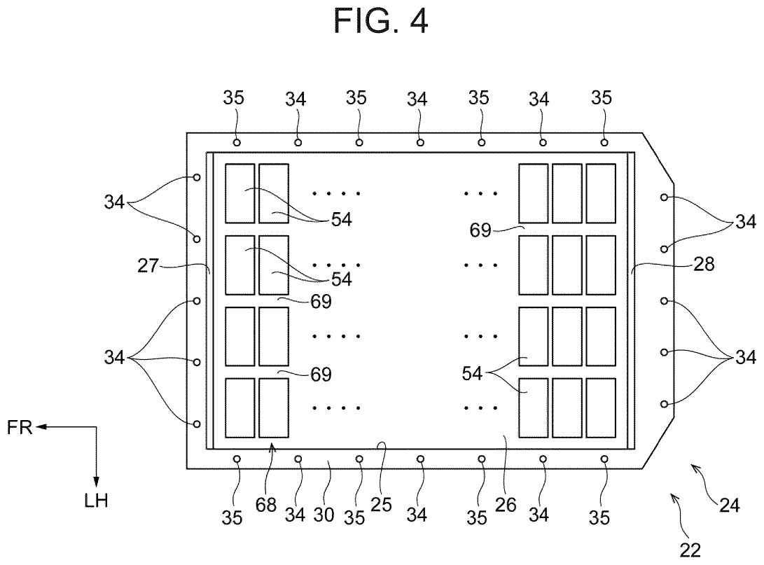

As shown in FIG. 4 to FIG. 6, the battery cells 54 are electrically connected to one another in a state of being arranged in an imaginary plane orthogonal to the height direction. That is, the battery cells 54 are arranged in the imaginary plane in such a manner that the base plate parts 56 on one side are located on a lower side while the lid parts 58 are arrayed in the right-left direction. A planar shape of the battery cells 54 arranged in the imaginary plane as a whole is a substantially rectangular shape that is longer in the front-rear direction than in the right-left direction. Hereinafter, the battery cells 54 arranged in the imaginary plane as a whole will be referred to as a planar battery unit 68. As shown in FIG. 4, in this embodiment, four battery cells 54 are arranged in the right-left direction and ten battery cells 54 are arranged in the front-rear direction. That is, the planar battery unit 68 includes 40 battery cells 54. Further, as shown in FIG. 4 to FIG. 6, three linear gaps 69 extending in the front-rear direction are left between the lid parts 58 of the battery cells 54 arrayed in the right-left direction. Further, a front-rear dimension of the planar battery unit 68 is slightly shorter than a front-rear dimension of the pressing ridge 40S. Further, the positive electrode terminal 60 and the negative electrode terminal 62 respectively of the battery cells 54 facing each other in the right-left direction are connected to each other by the metal busbar (not shown). Further, the positive electrode terminal 60 and the negative electrode terminal 62 that are located at a left edge portion of the planar battery unit 68 and adjacent to each other in the front-rear direction are connected to each other by the metal busbar (not shown). Further, the positive electrode terminal 60 and the negative electrode terminal 62 that are located at a right edge portion of the planar battery unit 68 and adjacent to each other in the front-rear direction are connected to each other by the metal busbar (not shown). That is, all the battery cells 54 composing one planar battery unit 68 are electrically connected to one another.

As shown in FIG. 5 and FIG. 6, the battery module 20 of this embodiment includes three planar battery units 68 of the same structure. The planar battery units 68 are electrically connected to one another by the busbars. The three planar battery units 68 are provided in a row in the height direction, and the cooler 72 is provided in each gap 70 left between adjacent two planar battery units 68. The cooler 72 is a hollow body of which a planar shape is substantially the same as a planar shape of the planar battery unit 68, and is composed of metal, such as aluminum. Further, each cooler 72 is in contact with the base plate parts 56 of the main body cases 55 of the respective battery cells 54 composing the two planar battery units 68 that are located above and below the cooler 72. End portions on one side of a pair of pipes (not shown) are connected to the coolers 72, and end portions on the other side of the pipes are connected to an electric pump, a heat exchanger, etc. outside the battery case 22. That is, a cooling liquid present inside the pair of pipes and the coolers 72 circulates through insides of the electric pump, the heat exchanger, the pair of pipes, and the coolers 72 by a force generated by the electric pump.

As shown in FIG. 5, the battery stack 52 configured as has been described above is disposed in an internal space of the lower case 24 in a state of being separated from the upper case 38, and is placed on a lower face of the bottom plate part 26. Further, as shown in FIG. 4, a front end portion of the battery stack 52 lies behind and away from the front plate part 27, and a rear end portion of the battery stack 52 lies in front of and away from the rear plate part 28. Further, as shown in FIG. 4 to FIG. 6, a left end portion of the battery stack 52 lies to the right of and away from the left side plate part 29, and a right end portion of the battery stack 52 lies to the left of and away from the right side plate part 29. Further, as shown in FIG. 5, an upper end portion of the battery stack 52 is located at a higher level than an upper end of the lower case 24.

Further, as shown in FIG. 5, the upper case 38 is put over an upper part of the lower case 24 housing the battery stack 52. While this is not shown, as a result, the pressing ridges 40S of the upper case 38 come into contact with upper faces of the main body cases 55 of the respective battery cells 54 composing the planar battery unit 68 in an uppermost tier of the battery stack 52, while the upper annular flange 44 faces the lower annular flange 30 from above with a small gap left therebetween.

Further, as shown in FIG. 6, a downward external force is applied to the upper case 38 to bring the upper annular flange 44 into contact with the lower annular flange 30 of the lower case 24. In this state, the bolts (fastening members) 75 are inserted into the respective first through-holes 48 formed in the upper annular flange 44 and the respective first through-holes 34 formed in the lower annular flange 30. The weld nuts (fastening members) 76 are screwed on lower portions of the respective bolts 75 protruding downward from the respective first through-holes 34, and head portions of the respective bolts 75 are pressure-welded on the upper face of the upper annular flange 44. Thus, the pressing ridges 40S are pressure-welded on the upper faces of the main body cases 55 of the respective battery cells 54 composing the planar battery unit 68 in the uppermost tier of the battery stack 52. This completes the battery module 20.

As shown in FIG. 1 and FIG. 2, the battery module 20 is fixed on the right and left rockers 12. That is, in a state where an upper face of a left edge portion of the upper annular flange 44 is in contact with a lower face of the bottom plate part 13 of the left rocker 12 and an upper face of a right edge portion of the upper annular flange 44 is in contact with a lower face of the bottom plate part 13 of the right rocker 12, bolts 78 are inserted into the respective second through-holes 35, 49 of the lower annular flange 30 and the upper annular flange 44 from below. Further, upper portions of the respective bolts 78 are screwed into corresponding weld nuts 15, and head portions of the respective bolts 78 are pressure-welded on the lower faces of the bottom plate parts 13. When the battery module 20 is thus fixed on the right and left rockers 12 using the bolts 78, the upper face of the upper case 38 is pressure-welded on a lower face of the cross-member 17 as shown in FIG. 6.

### Workings and Advantages

Next, the workings and advantages of the embodiment will be described.

The in-vehicle battery installation structure having been described above has the battery stack 52 that is configured with the battery cells 54 that are rectangular batteries stacked in the thickness direction thereof, each battery cell 54 having a rectangular parallelepiped shape and provided with the positive electrode terminal 60 and the negative electrode terminal 62 respectively on both end faces in the longitudinal direction. Further, the lower case 24 houses the battery stack 52 such that the thickness direction of the battery cells 54 and the height direction coincide with each other. Further, when the lower case 24 and the upper case 38 are fastened together by the bolts 75 and the weld nuts 76 that are fastening members, a force in the height direction (the thickness direction of the battery cells 54) is exerted from the bottom plate part 26 of the lower case 24 and the pressing ridges 40S of the upper case 38 onto the battery stack 52. Further, the lower face of the cross-member 17 extending in the vehicle-width direction exerts a downward force in the thickness direction of the battery cells 54 onto the upper face of the upper case 38. Thus, the in-vehicle battery installation structure of the embodiment makes it possible to exert a pressure in the thickness direction of the battery cells 54 onto each battery cell 54 by means of the cross-member 17, the lower case 24, and the upper case 38, without providing a spacer. This helps enhance the energy density of the battery module 20 having the lower case 24, the upper case 38, and the battery stack 52.

In the case where the battery cells are stacked in the front-rear direction to compose a battery stack and this battery stack is provided in the lower case, spacers are inserted between both end portions of the battery stack and inner faces of the front plate part and the rear plate part of the lower case. However, increasing the pressure exerted on the battery stack requires increasing the number of the battery cells composing the battery stack, and thus it is not easy to insert this battery stack and the spacers between the front plate part and the rear plate part. On the other hand, in the battery module 20 of the embodiment, the battery cells 54 are stacked in the height direction and the battery stack 52 is sandwiched by the lower case 24 and the upper case 38 in the height direction, so that even when the number of the planar battery units 68 to be stacked is increased to increase the pressure exerted on each battery cell 54, it is not difficult to assemble the battery module 20.

Further, the single cooler 72 is inserted in each gap 70 left between the planar battery units 68, and each cooler 72 is brought into contact with each of the battery cells 54 of the planar battery units 68 that are located above and below the cooler 72. Thus, the numerous battery cells 54 can be cooled by the small number of coolers 72.

Further, when the value of the pressure in the internal space of at least one battery cell 54 reaches the predetermined pressure due to, for example, occurrence of internal short-circuit, the safety valves 64, 66 open to discharge smoke generated in the internal space of that battery cell 54 to the outside of that battery cell 54. Internal short-circuit can occur, for example, when a minute foreign object present outside the battery cell 54 enters the battery cell 54 through a gap between the main body case 55 and the lid part 58. In this case, internal short-circuit occurs inside the battery cell 54, near the lid part 58. Therefore, when such short-circuit occurs, smoke generated inside the battery cell 54, near the lid part 58 can be efficiently discharged to the outside of the battery cell 54 through the safety valves 64, 66 provided on the lid parts 58.

Further, since the battery case 22 of the battery module 20 includes the heat dissipation holes 29S, smoke discharged through the safety valves 64, 66 located at a left edge portion and a right edge portion of the battery stack 52 (planar battery units 68) can be discharged to the outside of the battery module 20 through the heat dissipation holes 29S via gaps between the battery stack 52 and the side plate parts 29. In addition, in the battery module 20, smoke discharged through the safety valves 64, 66 provided at positions facing the linear gaps 69 can be discharged to the outside of the battery module 20 through the heat dissipation holes 29S via the linear gaps 69 and gaps between the battery stack 52 and the front plate part 27, the rear plate part 28, and the side plate parts 29.

Further, in the case where, for example, the battery cells are stacked in the front-rear direction to compose a battery stack, spacers are inserted between both end portions of the battery stack and inner faces of the front plate part 27 and the rear plate part 28, which requires the front plate part 27 and the rear plate part 28 to be substantially parallel to the height direction. However, when such spacers are not included as in the embodiment, the front plate part 27 and the rear plate part 28 can be inclined relative to the height direction. That is, since the battery module 20 does not need such spacers, a high degree of flexibility is allowed in designing the lower case 24 (the front plate part 27, the rear plate part 28).

While the in-vehicle battery module 20 according to the embodiment has been described above, design changes can be made thereto as appropriate within a range that does not depart from the gist of the present disclosure.

For example, the number of the battery cells 54 composing each planar battery unit 68 may differ from the aforementioned number.

The battery stack 52 may include two or four or more planar battery units 68.

The pressing ridges 40S may be omitted from the upper case 38, and the top plate part 40 may be brought into contact with the upper end portion of the battery stack 52.

The safety valve 64 (66) may be provided on only one of the lid parts 58 of the battery cell 54.

The planar shape of each cooler 72 may be a shape different from the planar shape of the planar battery unit 68. For example, the planar shape of each cooler 72 may be the same shape as a planar shape of all the battery cells 54 (in the embodiment, ten battery cells 54) as a whole that are arrayed in the front-rear direction. That is, four coolers may be provided in the gap 70. In this case, smoke having flowed from a battery cell 54 (safety valves 64, 66) of one planar battery unit 68 to the linear gaps 69 flows among the linear gaps 69 arrayed in the height direction via each gap between the coolers adjacent to each other in the right-left direction, so that the smoke can be efficiently discharged through the heat dissipation holes 29S to the outside of the battery module 20.

Ribs that extend linearly in the front-rear direction and ribs that extend linearly in the right-left direction may be provided on a bottom face (upper face) of the bottom plate part 26 of the lower case 24. Upper ends of these ribs are located at a lower level than lower ends of the positive electrode terminal 60, the negative electrode terminal 62, and the safety valves 64, 66 of the battery cells 54 placed on the bottom face of the bottom plate part 26. Further, ribs extending in the front-rear direction may be located in the linear gap 69 of the planar battery unit 68 in a lowermost tier, or ribs extending in the right-left direction may be located between the battery cells 54 adjacent to each other in the right-left direction of the planar battery unit 68 in the lowermost tier. Thus, the bottom plate part 26 can be mechanically reinforced by the ribs, and moreover the battery stack 52 can be positioned in the front-rear direction and the right-left direction with respect to the lower case 24 by the ribs.

A member different from the cross-member 17 and the upper case 38 may be interposed between the lower face of the cross-member 17 and the upper face of the upper case 38. In this case, a downward force is exerted from the lower face of the cross-member 17 onto the upper face of the upper case 38 through this member.

What is claimed is:

1. An in-vehicle battery installation structure comprising:
a battery stack configured with a plurality of rectangular batteries stacked in a thickness direction of the rectangular batteries, each rectangular battery having a rectangular parallelepiped shape and provided with a terminal on each end face in a longitudinal direction;
a lower case that has an opening in an upper face and houses the battery stack such that the thickness direction and a height direction coincide with each other;
an upper case which is mounted on an upper part of the lower case so as to close the opening and of which a lower face is open;
a fastening member that fastens the lower case and the upper case together such that a force in the thickness direction is exerted from the lower case and the upper case onto the battery stack; and
a cross-member which is a part of a vehicle body framework member supporting the lower case and the upper case and extends in a vehicle-width direction, and of which a lower face exerts a force in the thickness direction onto an upper face of the upper case.

2. The in-vehicle battery installation structure according to claim 1, wherein:
the battery stack has a plurality of planar battery units each configured with a plurality of the rectangular batteries arranged in a plane orthogonal to the thickness direction;
the planar battery units are arranged in the thickness direction; and
in a gap left between two adjacent ones of the planar battery units, a single cooler is provided that comes into contact with each of the rectangular batteries composing the planar battery units.

3. The in-vehicle battery installation structure according to claim 1, wherein the lower face of the cross-member and the upper face of the upper case come into contact with each other.
